(19) United States
(12) Patent Application Publication
(10) Pub. No.: US 2026/0239330 A1
(43) Pub. Date: Aug. 13, 2026

(54) METHOD TO CONFIGURE OCC CONSIDERING THE CFO GROUPING

(71) Applicant: Telefonaktiebolaget LM Ericsson (publ), Stockholm (SE)

(72) Inventors: Chunhui ZHANG, Stockholm (SE); Stefan Eriksson LÖWENMARK, Stockholm (SE); Yuande TAN, Beijing (CN); Gerardo Agni MEDINA ACOSTA, Stockholm (SE)

(21) Appl. No.: 19/532,731

(22) Filed: Feb. 6, 2026

Related U.S. Application Data
(60) Provisional application No. 63/755,790, filed on Feb. 7, 2025.

(51) Int. Cl. H04W 72/121; H04J 13/00; H04W 72/0446; H04W 72/0453

(52) U.S. Cl. CPC H04W 72/121; H04J 13/004; H04W 72/0446; H04W 72/0453

(57) ABSTRACT

A method, system and apparatus are disclosed. A method in a network node configured to communicate with a plurality of user equipments (UEs) is described. The method includes measuring a frequency error of received signals that are transmitted from the plurality of UEs. The method also includes grouping the UEs of the plurality of UEs for Orthogonal Cover Code (OCC) scheduling according to an OCC scheme, the grouping being based at least in part on a condition, the condition being based at least in part on a characteristic of the frequency error. The method further includes scheduling at least one UE of the group of UEs for OCC transmission using the OCC scheme upon occurrence of the condition.

### CROSS REFERENCE OF RELATED APPLICATION

This application claims priority to U.S. Provisional Application No. 63/755,790, filed Feb. 7, 2025, the entirety of which is incorporated herein by reference.

### FIELD

The present disclosure relates to wireless communications, and in particular, to configuration of Orthogonal Cover Code (OCC) considering Carrier Frequency Offset (CFO) grouping.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipments (UE), as well as communication between network nodes and between UEs. The 3GPP is also developing standards for Sixth Generation (6G) wireless communication networks.

Non-Terrestrial Networks (NTN) was introduced for NR, Long Term Evolution-Machine Type Communication (LTE-MTC), and Narrow Band Internet of Things (NB-IoT) in 3GPP Release 17 (3GPP Rel-17). Functionalities have also been added to NR for operating as a non-terrestrial network. In 3GPP Release 19 (3GPP Rel-19), NTN is expected to continue to evolve and as part of its evolution, may increase the uplink capacity/throughput of the Physical Uplink shared Channel (PUSCH). A justification behind this enhancement has been described as follows:

Offer optimized capacity performance on uplink through multiplexing techniques, motivated by the following:
The coverage of NTN satellites is very wide, and considering device density, it is expected that a large number of UEs will be within a satellite's coverage. Especially for low earth orbit (LEO), a large number of UEs in coverage must succeed in transmitting desired data during a satellite coverage, which means that rapid access to and release of satellite resources is required;
The total spectrum resources available to the network will be limited especially in the early phases of NR NTN deployments;
Some users will require higher resources than others, depending on their traffic patterns. Therefore, further granularity of resource multiplexing may significantly improve system capacity efficiency; and
Possibly to allocate higher per-UE resources to better support VONR/VoIP services in coverage-limited scenarios.

As a result of several 3GPP Rel-19 workshops and discussions during the 3GPP Radio Access Network (RAN) Plenary #102, the 3GPP Rel-19 objective that is aiming to increase the uplink capacity/throughput for Physical Uplink Shared Channel (PUSCH) is as follows:

### Uplink Capacity/Throughput Enhancement for FR1-NTN [RAN1, RAN2, RAN4]

Study then specify, if beneficial, discrete Fourier transform (DFT)-s-orthogonal frequency division multiplexing (OFDM) PUSCH enhancements via Orthogonal Cover Codes (OCC):
   Determine the achievable capacity improvement to be targeted taking into account realistic impairments (e.g. Doppler, time variation, phase distortion, etc.);
   Specify necessary signaling, if needed;
   Update RF requirements accordingly, if needed;
   Note: The study may consider orthogonal cover codes across OFDM symbols, across slots, and/or within an OFDM symbol; and
   Note: the study phase is targeted to be completed by RAN #104. Notes for this objective:
   The enhancement is not targeting improvements/impacts of multi-user multiple input multiple output (MU-MIMO) capability;
   The enhancement is not targeted to PUSCH demodulation reference signal (DMRS);
   No enhancement for initial access;
   Enhancements to physical random access channel (PRACH) are not in scope; and
   This feature may be applicable for UEs operating in terrestrial networks based on a common design.

The above cited 3GPP Rel-19 objective was kicked-off in RAN1 #116, resulting in the following initial agreements:

### Agreement

Adopt the table below for assumptions for Evaluation parameters for link level evaluation in NR NTN UL capacity and throughput enhancements:

| Parameter | Value |
|---|---|
| Channel model | NTN-TDL-C Rural, 30° elevation angle |
| Carrier frequency | 2 GHz |
| Subcarrier spacing | 15 kHz |
| UE speed | 3 km/h |
| Frequency hopping | No frequency hopping |
| PUSCH mapping type A | 14 OS- for OCC across slots including DMRS |
| with | |
| HARQ configuration | No HARQ |
| Channel coding | LDPC |
| TBS | Reported by companies, e.g. |
| | ≈184 bits payload @AMR 4.75 kbps96 |
| | bits @Low data rate |
| DMRS configuration/ | 1 port per UE |
| port/bundling | Reported by companies |
| | DMRS positions for single-symbol DMRS |
| | and optional double-symbol DMRS for PUSCH |
| | mapping type A defined in Table 6.4.1.1.3-3 |
| | and Table 6.4.1.1.3-4 respectively with |
| | l_{d} = 14, l₀ = 2 and pos1 in [38.211]. |
| | up to 8 DMRS Ports |
| | Optional DMRS Bundling |
| PRBs/MCS | Reported by companies, e.g. |
| | 1 PRB, 2 PRBs |
| | MCS in Table 6.1.4.1-2 in [TS 38.214] |
| Max repetition number | Reported by companies - up to 20 for VoIP, |
| | up to 32 for low data rates |
| OCC length | Reported by companies, e.g. |
| | Up to 8 |
| OCC sequence | Reported by companies, e.g. |
| | Walsh sequences in Table 6.3.2.6.3-1 in |
| | TS38.211 v18.5.0 |
| | DFT sequence in Table 6.3.2.6.3-2 in |
| | TS38.211 v18.5.0 |
| Antenna configuration at | 1Rx |
| Satellite | |
| Antenna configuration at | 1Tx |
| UE | |

### Agreement

Adopt the table below for assumptions for modelling impairments for link level evaluation in NR NTN UL capacity and throughput enhancements.

| Parameter | Value |
|---|---|
| TO | Reported by companies |
| | With TO: Uniform selection from [−0.94us, 0.94us], |
| | where 0.94us = 29Ts |
| | Optional without TO |
| FO | Reported by companies |
| | Uniform selection from [−0.1 ppm, +0.1 ppm], |
| | Variation of frequency error is negligible. |
| | Optional: with lower maximum residual FO, |
| | to be reported by companies |
| Timing drift | Optional |
| Receiver algorithm | To be reported by companies, e.g. |
| | MMSE |
| Channel estimation | Real channel estimation |

### Agreement

Adopt the table below for assumptions for KPIs for link level evaluation in NR NTN UL capacity and throughput enhancements:

| Parameter | Value |
|---|---|
| Number of code-division | Reported by companies (up to 8) |
| multiplexed users | |
| KPI - SNR for a target | As in Rel-18 (otherwise reported by |
| BLER per UE | companies) |
| | VoIP: SNR @2% BLER |
| | For other cases: SNR @10% BLER |
| KPI - Aggregated | Reported by companies |
| throughput | Total throughput according to number |
| | of code-division multiplexed users (up to 8) |
| | Note: companies should also report the |
| | throughput for the case without OCC |

The network may schedule multiple UEs to perform an OCC-based transmission in such a way that the UEs may simultaneously transmit on the same time-frequency domain uplink resources as to increase the system capacity. At the receiver side and for one UE at a time, the gNB's receiver (i.e., network node receiver) needs to implement coherent combining to mitigate interference from other UEs after multiplying a local orthogonal cover code.

However, there is a different frequency error from different UEs. When a network node compensates the frequency offset/error for one UE, and the frequency error is inversely proportional to signal to noise ratio (SNR) of a synchronization signal broadcasted from network, it is expected from the network node that the variance of frequency offset/error and the mean of the frequency error should not change during the OCC spreading in the time-domain. The network node may group the UE with similar frequency error performance in terms of the variance and mean of detected frequency error, e.g., a mean frequency error is zero and the variance of the frequency error is small. However, there are events that could trigger the change of frequency error and invalidate the condition of the carrier frequency offset (CFO) grouping for the OCC scheduling.

Thus, a mechanism is needed between network node and UE to maintain a stable frequency error performance within a certain period of time.

### SUMMARY

Some embodiments advantageously provide methods, network nodes and UEs for configuration of orthogonal cover codes (OCC) considering carrier frequency offset (CFO) grouping.

One or more embodiments provide a method to configure the OCC time domain in a network node, based on the detected frequency error from a number of the UEs. The method may include one or more of the following:
1. Measuring the frequency error of the received signals transmitted from a number of UEs;
2. Grouping the UEs for OCC scheduling with a condition, e.g., one or both of:
a. The variance of frequency error of each UE is below a certain threshold; and/or
b. The difference of the mean frequency error of each UE is below a certain threshold; and/or
3. Scheduling the UEs qualified with the condition in step 2 using the OCC scheme with one group.

One or more embodiments provide a method for a UE, where when the OCC scheduling is received, the rules to make the frequency pre-compensation may be applied and may include one or more of the following:
1. For a single occasion of contiguous OCC transmission (e.g., OCC2 or OCC4):
a. The frequency pre-compensation may not be applied during the OCC transmission duration;
b. The frequency pre-compensation may not be applied before the OCC transmission and after the OCC scheduling indication is received from network;
C. The OCC transmission may be dropped if frequency pre-compensation is applied before the OCC transmission and after the OCC scheduling indication is received from the network node; and/or
d. All the OCC transmission may be dropped if frequency pre-compensation is applied during the time slots scheduled for OCC transmission.

Some embodiments provide rules for the UE scheduled for OCC transmission to apply the frequency pre-compensation and/or a method for a network node to group the UE to schedule the OCC with a condition of the frequency error performance which may be measured on the received signal transmitted from UE. In some embodiments, OCC performance may be assured with the rules applied and the method for grouping the UE for OCC scheduling at the network node.

According to one aspect, a method in a network node includes measuring a frequency error of received signals that are transmitted from the plurality of UEs. The process includes grouping the UEs of the plurality of UEs for Orthogonal Cover Code (OCC) scheduling according to an OCC scheme, the grouping being based at least in part on a condition, the condition being based at least in part on a characteristic of the frequency error. The process includes scheduling at least one UE of the group of UEs for OCC transmission using the OCC scheme upon occurrence of the condition.

In some embodiments, a characteristic of the frequency error includes at least one of a variance of the frequency error and a difference of the mean frequency error. In some embodiments, the condition includes at least one of: the variance of the frequency error being below a first predetermined threshold; and the difference of the mean frequency error being below a second predetermined threshold. In some embodiments, the scheduling includes scheduling an OCC2 for any group of two of the UEs and scheduling OCC4 with a Carrier Frequency Offset (CFO) grouping criteria. In some embodiments, the method includes applying frequency pre-compensation and applying a rule for frequency pre-compensation, the rule including at least one of: not applying frequency pre-compensation during an OCC transmission duration; not applying frequency pre-compensation before the OCC transmission or after an OCC scheduling indication is received from the network node; dropping an OCC transmission when the frequency pre-compensation is applied before the OCC transmission and after an OCC scheduling indication is received from the network node; and dropping OCC transmissions when the frequency pre-compensation is applied during time slots scheduled for OCC transmission. In some embodiments, the rule is applied in case of a single occasion of contiguous OCC transmission. In some embodiments, the rule is applied when scheduling information indicates use of an OCC codeword longer than 2. In some embodiments, the rule is applied in an event that causes a change in carrier frequency offset (CFO). In some embodiments, the rule is applied for a scheduled OCC length 4 transmission when an event that causes a change in carrier frequency offset (CFO) occurs.

According to another aspect, a network node configured to communicate with a plurality of UEs includes processing circuitry configured to measure a frequency error of received signals that are transmitted from the plurality of UEs. The processing circuitry is also configured to group the UEs of the plurality of UEs for Orthogonal Cover Code (OCC) scheduling according to an OCC scheme, the grouping being based at least in part on a condition, the condition being based at least in part on a characteristic of the frequency error. The processing circuitry is configured to schedule at least one UE of the group of UEs for OCC transmission using the OCC scheme upon occurrence of the condition.

In some embodiments, a characteristic of the frequency error includes at least one of a variance of the frequency error and a difference of the mean frequency error. In some embodiments, the condition includes at least one of: the variance of the frequency error being below a first predetermined threshold; and the difference of the mean frequency error being below a second predetermined threshold. In some embodiments, the scheduling includes scheduling an OCC2 for any group of two of the UEs and scheduling OCC4 with a Carrier Frequency Offset (CFO) grouping criteria. In some embodiments, the method includes applying frequency pre-compensation and applying a rule for frequency pre-compensation, the rule including at least one of: not applying frequency pre-compensation during an OCC transmission duration; not applying frequency pre-compensation before the OCC transmission or after an OCC scheduling indication is received from the network node; dropping an OCC transmission when the frequency pre-compensation is applied before the OCC transmission and after an OCC scheduling indication is received from the network node; and dropping OCC transmissions when the frequency pre-compensation is applied during time slots scheduled for OCC transmission. In some embodiments, the rule is applied in case of a single occasion of contiguous OCC transmission. In some embodiments, the rule is applied when scheduling information indicates use of an OCC codeword longer than 2. In some embodiments, the rule is applied in an event that causes a change in carrier frequency offset (CFO). In some embodiments, the rule is applied for a scheduled OCC length 4 transmission when an event that causes a change in carrier frequency offset (CFO) occurs.

In some embodiments, a method in a UE includes, for an occasion of contiguous orthogonal cover code (OCC) transmission, applying a rule for frequency pre-compensation, the rule including at least one of: not applying frequency pre-compensation during an OCC transmission duration; not applying frequency pre-compensation before the OCC transmission or after an OCC scheduling indication is received from the network node; dropping an OCC transmission when the frequency pre-compensation is applied before the OCC transmission and after an OCC scheduling indication is received from the network node; and dropping OCC transmissions when the frequency pre-compensation is applied during time slots scheduled for OCC transmission.

In some embodiments, the rule is applied in case of a single occasion of contiguous OCC transmission. In some embodiments, the rule is applied when scheduling information indicates use of an OCC codeword longer than 2. In some embodiments, the rule is applied in an event that causes a change in carrier frequency offset (CFO). In some embodiments, the rule is applied for a scheduled OCC length 4 transmission when an event that causes a change in CFO occurs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a user equipment over a wireless connection according to some embodiments of the present disclosure;

FIG. 3 is a schematic diagram of another example network architecture illustrating a communication system according to principles disclosed herein;

FIG. 4 is a flowchart of an example process in a network node according to some embodiments of the present disclosure;

FIG. 5 is a flowchart of an example process in a user equipment according to some embodiments of the present disclosure;

FIG. 6 is a flowchart of another example process in a network node according to some embodiments of the present disclosure;

FIG. 7 is a flowchart of another example process in a user equipment according to some embodiments of the present disclosure;

FIG. 8 shows an example comparison of OCC performance of OCC4 according to some embodiments of the present disclosure;

FIG. 9 an example of a single OCC occasion transmission according to some embodiments of the present disclosure; and

FIG. 10 shows another example of a multiple OCC occasion transmission according to some embodiments of the present disclosure.

### DETAILED DESCRIPTION

Before describing in detail exemplary embodiments, it is noted that the embodiments reside primarily in combinations of apparatus components and processing steps related to configuration of OCC considering CFO grouping. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a wireless device (WD) or a radio network node.

In some embodiments, the non-limiting terms wireless device (WD) or a user equipment (UE) are used interchangeably. The UE herein may be any type of user equipment capable of communicating with a network node or another UE over radio signals, such as a wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR) and/or 6G, may be used in this disclosure, this should not be seen as limiting the scope of the disclosure to only the aforementioned system. It is contemplated that other 3GPP systems may make use of the concepts and arrangements disclosed herein. For example, a disclosure relating to NR may also be implementable in a 6G system and/or an LTE system, a disclosure relating to 6G may also be implementable in a NR and/or LTE system, and a disclosure relating to LTE may also be implementable in a NR and/or 6G system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of user equipments and/or network nodes. In other words, it is contemplated that the functions of the network node and user equipment described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

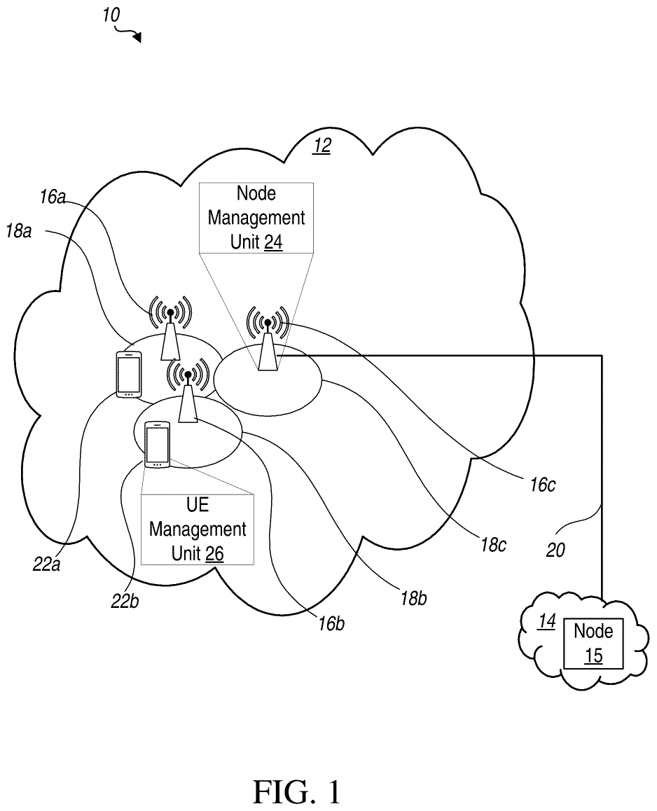

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G) and/or 6G, which comprises an access network 12, such as a radio access network, and a core network 14. The core network 14 includes one or more network nodes 15. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as user equipments 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

As one example, in certain embodiments, access network 12 may contain some access network nodes 16 that support 3GPP radio access technologies (RAT), such as LTE or NR, while other access network nodes 16 support (or the same access network nodes 16 additionally support) non-3GPP RATs, such as Wi-Fi or a proprietary RAT. As another example, communication system 10 may support multiple generations of related communication standards (e.g., 4G, 5G and 6G 3GPP communication standards) and, as a result, may include an access network 12 and/or a core network 14 that supports multiple different standard generations or may include multiple access networks 12 and/or multiple core networks 14 with individual networks supporting different standards generations.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN, a gNB for NR/NG-RAN (i.e. being configured for multi-radio dual connectivity (MR-DC), such as E-UTRAN (Evolved-UMTS Terrestrial Radio Access Network) New Radio-Dual Connectivity (EN-DC) and/or Wi-Fi. In addition, although not shown, system 10 may include one or more NTNs. Further, any of the networks of system 10 may be associated with or comprise an NTN.

A network node 16 is configured to include a node management unit 24 which is configured to perform any step and/or task and/or process and/or method and/or feature described in the present disclosure, e.g., network node functions. A user equipment 22 is configured to include a UE management unit 26 which is configured to perform any step and/or task and/or process and/or method and/or feature described in the present disclosure, e.g., UE functions.

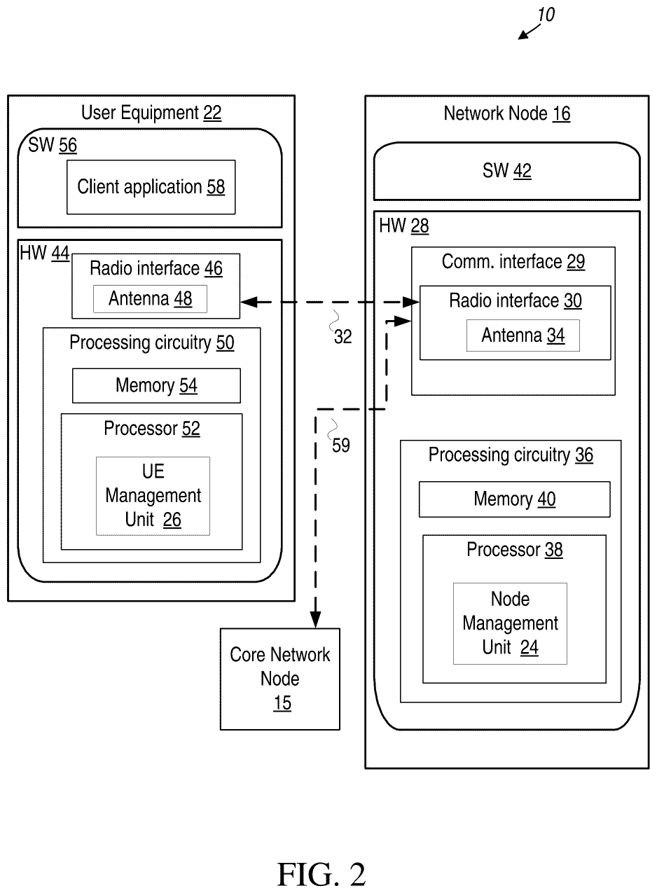

Example implementations, in accordance with an embodiment, of the UE 22 and network node 16 discussed in the preceding paragraphs will now be described with reference to FIG. 2.

The communication system 10 includes a network node 16 provided in a communication system 10 and including hardware 28 enabling it to communicate with the UE 22. The hardware 28 may include a communication interface 29 comprising a radio interface 30 for setting up and maintaining at least a wireless connection 32 with a UE 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a node management unit 24 which is configured to perform any step and/or task and/or process and/or method and/or feature described in the present disclosure, e.g., network node functions

The network node 16 may be composed of multiple distinct network entities (e.g., a NodeB entity and a RNC entity, or a BTS entity and a BSC entity, etc.), which may each have or utilize their own respective physical components. In certain scenarios in which the network node 16 comprises multiple such entities (e.g., BTS and BSC), one or more of the separate entities may be shared among several network nodes. For example, a single RNC may control multiple NodeBs. In such a scenario, each unique NodeB and RNC pair, may in some instances be considered a single separate network node. In some embodiments, the network node 16 may be configured to support multiple radio access technologies (RATs). In such embodiments, some components may be duplicated (e.g., separate memories 40 or portions of memory 40 for different RATs) and some components may be reused (e.g., a same antenna may be shared by different RATs). The network node 16 may also include multiple sets of the various illustrated components for different wireless technologies integrated into network node 16, for example GSM, WCDMA, LTE, NR, Wi-Fi (e.g., according to an IEEE 802.11 family standard), Zigbee, Z-wave, LoRaWAN, Radio Frequency Identification (RFID) or Bluetooth wireless technologies. These wireless technologies may be integrated into the same or different chip or set of chips and other components within network node 16.

In certain alternative embodiments, network node 16 may be capable of wireless communication but does not include separate radio front-end circuitry, instead, the processing circuitry 36 includes radio front-end circuitry and is connected to the antenna 34. Similarly, in some embodiments, all or some of the RF receivers, transmitters and/or transceivers are part of the radio interface 30. In still other embodiments, the communication interface 29 includes one or more ports or terminals, the radio interface 30, and the RF receiver, transmitter and/or transceiver, and the communication interface 31 communicates with baseband processing circuitry, which is part of a digital unit (not shown).

The antenna 34 may include one or more antennas, or antenna arrays, configured to send and/or receive wireless signals. The antenna 34 may be coupled to the radio front-end circuitry in radio interface 30 and may be any type of antenna capable of transmitting and receiving data and/or signals wirelessly. In certain embodiments, the antenna 34 is separate from the network node 16 and connectable to the network node 16 through one or more interfaces or ports.

Network node 15 may include one or more components described above with respect to network node 16, e.g., communication interface 29, radio interface 30, antenna 34, ports, processing circuitry 36, processor 38, memory 40 and software 42. These elements of network node 15 may be arranged such that network node 15 may perform various core network functions. Network node 15 may communicate wirelessly or via a wired connection with network nodes 16 via communication link 59.

The communication system 10 further includes the UE 22 already referred to. The UE 22 may have hardware 44 that may include a radio interface 46 configured to set up and maintain a wireless connection 32 with a network node 16 serving a coverage area 18 in which the UE 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

Communication functions of the radio interface 46 may include cellular communication, Wi-Fi communication (e.g., according to an IEEE 802.11 family standard), LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

The hardware 44 of the UE 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 56, which is stored in, for example, memory 54 at the UE 22, or stored in external memory (e.g., database, storage array, network storage device, etc.) accessible by the UE 22. The software 56 may be executable by the processing circuitry 50. The software 56 may include a client application 58. The client application 58 may be operable to provide a service to a human or non-human user via the UE 22.

The processing circuitry 50 may be configured to control any of the methods and/or processes described herein and/or to cause such methods, and/or processes to be performed, e.g., by UE 22. The processor 52 corresponds to one or more processors 52 for performing UE 22 functions described herein. The UE 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to UE 22. For example, the processing circuitry 50 of the user equipment 22 may include a UE management unit 26 which is configured to perform any step and/or task and/or process and/or method and/or feature described in the present disclosure, e.g., UE functions.

In some embodiments, the inner workings of the network node 16 and UE 22 may be as shown in FIG. 2 and independently, the surrounding network topology may be that of FIG. 1.

The wireless connection 32 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as node management unit 24 and UE management unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

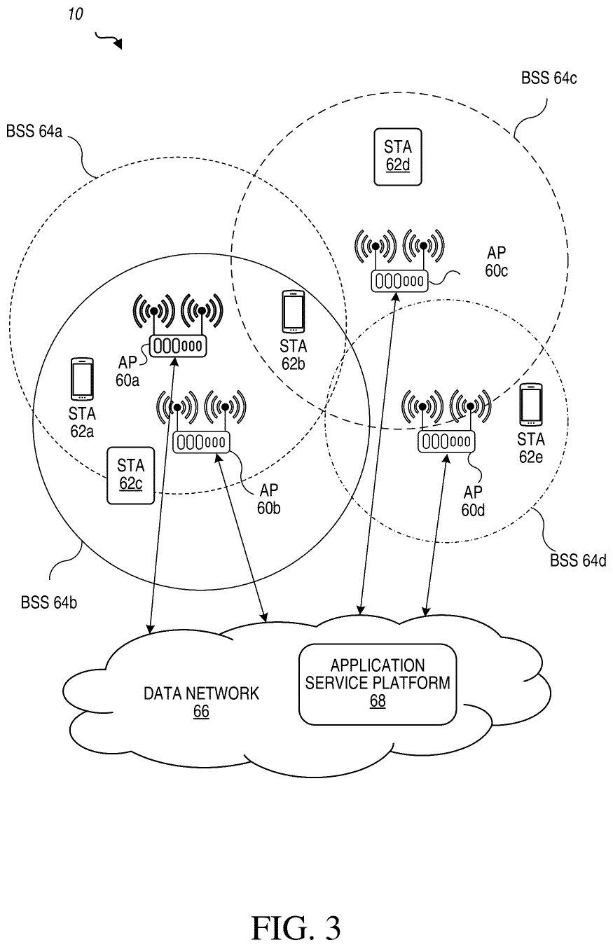

FIG. 3 is another example of a communication system 10 according to some embodiments. As used herein, the communication system 10 of FIG. 3 includes multiple access points (APs) 60 (with four example APs 60a, 60b, 60c, and 60d being depicted) and multiple wireless devices, referred to in the context of communication system 10 of FIG. 3 as stations (STAs) 62 (referred to individually as STA 62a, STA 62b, STA 62c, STA 62d, and STA 62e). STA 62a is served by AP 60a in a first basic service set (BSS) 64a. STA 60b and STA 60c are served by AP 60b in a second BSS, BSS 64b. STA 62d is served by AP 60c in a third BSS, BSS 64c. STA 62e is served by AP 60d in a fourth BSS, BSS 64d. Stations 62 may be non-AP STAs and correspond to various kinds of wireless devices, for example, user terminals, such as mobile or stationary computing devices like smartphones, laptop computers, desktop computers, tablet computers, gaming devices, head-mounted displays (HMDs) for Augmented Reality (AR) or Virtual Reality (VR), or the like, including UEs 22 that are shown and described with respect to FIGS. 1 and 2. In other words, in some embodiment, STA 62 is a UE 22. Further, stations 62 could, for example, correspond to other kinds of equipment like smart home devices, printers, multimedia devices, data storage devices, or the like.

Each of STAs 62 may connect through a radio link to one of APs 60. For example, depending on location or channel conditions experienced by a given STA 62, the STA may select an appropriate AP and BSS for establishing the radio link. The radio link may be based on one or more orthogonal frequency-division multiplexing (OFDM) carriers from a frequency spectrum that is shared on the basis of a contention-based mechanism, e.g., an unlicensed or license exempt band like 2.4 GHz Industrial, Scientific, and Medical (ISM) band, the 5 GHz band, the 6 GHz band, or the 60 GHz band.

Each AP 60 may provide data connectivity to STAs 62 connected to a particular AP 60. As illustrated, APs 60 may be connected to a data network 66. In this way, APs 60 may also provide data connectivity between STAs 62 and other entities, e.g., to one or more servers, service providers, data sources, data sinks, user terminals, or the like. Accordingly, the radio link established between a given STA 62 and its serving AP 60 may be used for providing various kinds of services to STA 62, e.g., a voice service, a multimedia service, or other data service. Such services may be based on applications that are executed on STA 62 and/or on a device linked to STA 62. By way of example, FIG. 3 illustrates an application service platform 68 provided in data network 66. The application(s) executed on STA 62 and/or on one or more other devices linked to STA 62 may use the radio link for data communication with one or more other STA 62 and/or the application service platform 68, thereby enabling utilization of the corresponding service(s) at STA 62.

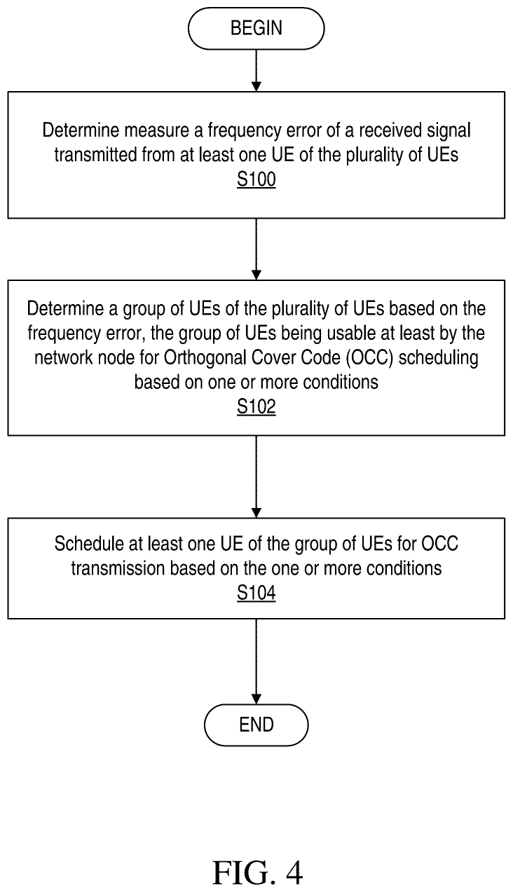

FIG. 4 is a flowchart of an example process in a network node 16 according to some embodiments of the present disclosure. One or more blocks described herein may be performed by one or more elements of network node 16 such as by one or more of processing circuitry 36 (including the node management unit 24), processor 38, and/or radio interface 30. Network node 16 is configured to measure (Block S100) a frequency error of a received signal transmitted from at least one UE 22 of the plurality of UEs 22 and determine (Block S102) a group of UEs 22 of the plurality of UEs 22 based the frequency error, where the group of UEs 22 is usable at least by the network node 16 for Orthogonal Cover Code (OCC) scheduling based on one or more conditions. Network node 16 is also configured to schedule (Block S104) at least one UE 22 of the group of UEs 22 for OCC transmission based on the one or more conditions.

In some embodiments, the one or more conditions include one or both of a variance of the frequency error associated with each UE 22 is below a first predetermined threshold and a difference of a mean frequency error associated with each UE 22 is below a second predetermined threshold.

In some other embodiments, the group is associated with an OCC scheme.

In some embodiments, the scheduling includes scheduling an OCC2 for any group of two of the UEs 22 and scheduling OCC4 with a Carrier Frequency Offset (CFO) grouping criteria.

In some other embodiments, the network node 16 is further configured to one or both of transmit a first indication indicating the UE 22 not to adjust one or more of CFO, transmission power, and phase, and transmit a second indication indicating the UE 22 to drop an OCC transmission.

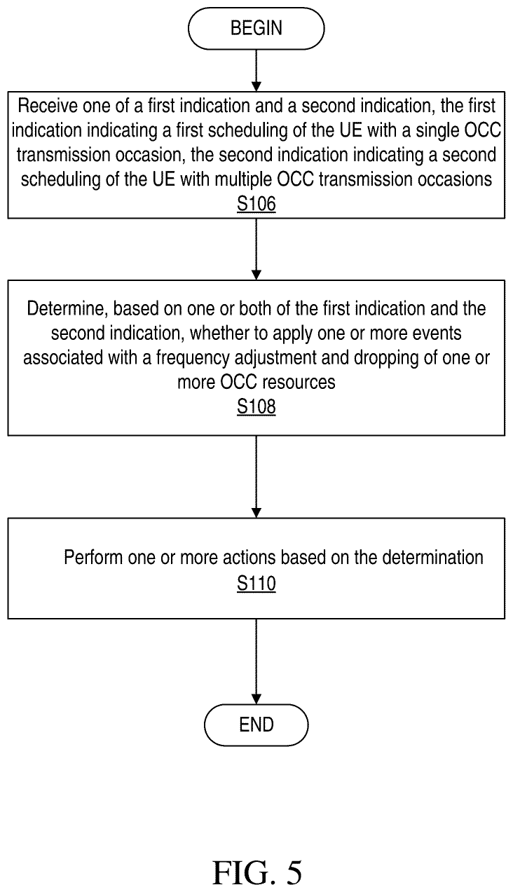

FIG. 5 is a flowchart of an example process in a user equipment 22 according to some embodiments of the present disclosure. One or more blocks described herein may be performed by one or more elements of user equipment 22 such as by one or more of processing circuitry 50 (including the UE management unit 26), processor 52, and/or radio interface 46. User equipment 22 is configured to receive (Block S106) one of a first indication and a second indication, where the first indication indicates a first scheduling of the UE 22 with a single OCC transmission occasion, and the second indication indicates a second scheduling of the UE 22 with multiple OCC transmission occasions. The UE 22 is also configured to determine (Block S108), based on one or both of the first indication and the second indication, whether to apply one or more events associated with a frequency adjustment and dropping of one or more OCC resources and perform (Block S110) one or more actions based on the determination.

In some embodiments, if one or both of the first indication and the second indication further indicates usage of an OCC codeword larger than 2 or usage of an OCC length 4 transmission for a first OCC transmission, and if one of one or more events cause a Carrier Frequency Offset change, the one or more actions include one or more of: (A) determining not to apply the one or more events during OCC transmission duration; (B) determining not to apply the one or more events applied before the OCC transmission and after the corresponding OCC scheduling indication is received from network node 16; (C) dropping an OCC transmission if the one or more events is applied before the OCC transmission and after the corresponding OCC scheduling indication is received from network node 16; and (D) dropping all OCC transmissions if one of the events is applied during one or more time slots scheduled for the OCC transmission.

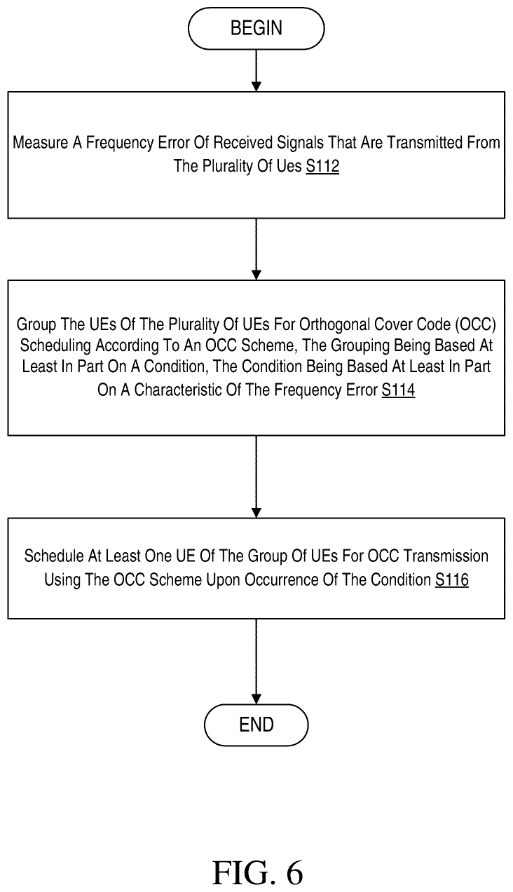

FIG. 6 is a flowchart of an example process in a network node 16 according to some embodiments of the present disclosure. One or more blocks described herein may be performed by one or more elements of network node 16 such as by one or more of processing circuitry 36 (including the node management unit 24), processor 38, and/or radio interface 30. Network node 16 is configured to measure (Block S112) a frequency error of received signals that are transmitted from the plurality of UEs 22. The process includes grouping (Block S114) the UEs 22 of the plurality of UEs 22 for Orthogonal Cover Code (OCC) scheduling according to an OCC scheme, the grouping being based at least in part on a condition, the condition being based at least in part on a characteristic of the frequency error. The process includes scheduling (Block S116) at least one UE 22 of the group of UEs 22 for OCC transmission using the OCC scheme upon occurrence of the condition.

In some embodiments, a characteristic of the frequency error includes at least one of a variance of the frequency error and a difference of the mean frequency error. In some embodiments, the condition includes at least one of: the variance of the frequency error being below a first predetermined threshold; and the difference of the mean frequency error being below a second predetermined threshold. In some embodiments, the scheduling includes scheduling an OCC2 for any group of two of the UEs 22 and scheduling OCC4 with a Carrier Frequency Offset (CFO) grouping criteria. In some embodiments, the method includes applying frequency pre-compensation. In some embodiments, the method includes applying a rule for frequency pre-compensation, the rule including at least one of: not applying frequency pre-compensation during an OCC transmission duration; not applying frequency pre-compensation before the OCC transmission or after an OCC scheduling indication is received from the network node 16; dropping an OCC transmission when the frequency pre-compensation is applied before the OCC transmission and after an OCC scheduling indication is received from the network node 16; and dropping OCC transmissions when the frequency pre-compensation is applied during time slots scheduled for OCC transmission. In some embodiments, the rule is applied in case of a single occasion of contiguous OCC transmission. In some embodiments, the rule is applied when scheduling information indicates use of an OCC codeword longer than 2. In some embodiments, the rule is applied in an event that causes a change in carrier frequency offset (CFO). In some embodiments, the rule is applied for a scheduled OCC length 4 transmission when an event that causes a change in carrier frequency offset (CFO) occurs.

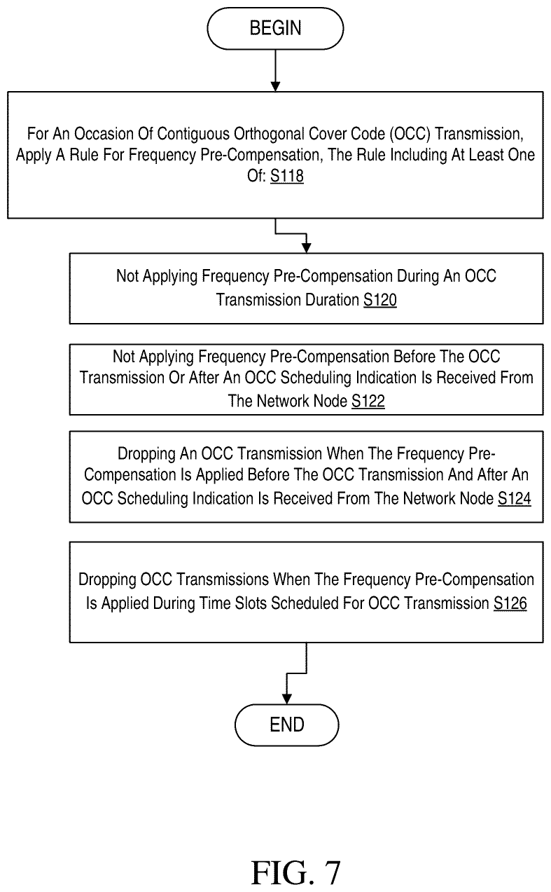

FIG. 7 is a flowchart of an example process in a user equipment 22 according to some embodiments of the present disclosure. One or more blocks described herein may be performed by one or more elements of user equipment 22 such as by one or more of processing circuitry 50 (including the UE management unit 26), processor 52, and/or radio interface 46. User equipment 22 is configured to, for an occasion of contiguous orthogonal cover code (OCC) transmission, applying (Block S118) a rule for frequency pre-compensation, the rule including at least one of: not applying (Block S120) frequency pre-compensation during an OCC transmission duration; not applying frequency (Block S122) pre-compensation before the OCC transmission or after an OCC scheduling indication is received from the network node 16; dropping (Block S124) an OCC transmission when the frequency pre-compensation is applied before the OCC transmission and after an OCC scheduling indication is received from the network node 16; and dropping (Block S126) OCC transmissions when the frequency pre-compensation is applied during time slots scheduled for OCC transmission.

In some embodiments, the rule is applied in case of a single occasion of contiguous OCC transmission. In some embodiments, the rule is applied when scheduling information indicates use of an OCC codeword longer than 2. In some embodiments, the rule is applied in an event that causes a change in carrier frequency offset (CFO). In some embodiments, the rule is applied for a scheduled OCC length 4 transmission when an event that causes a change in CFO occurs.

Having described the general process flow of arrangements of the disclosure and having provided examples of hardware and software arrangements for implementing the processes and functions of the disclosure, the sections below provide details and examples of arrangements for configuration of OCC considering CFO grouping.

In some embodiments, the frequency error measurement at network node 16 is referred to as carrier frequency offset (CFO). CFO may be used inter-changeably with the frequency error performance. One or more UE 22 functions described below may be performed by one or more of processing circuitry 50, processor 52, UE management unit 26, radio interface 46, etc. One or more network node 16 functions described below may be performed by one or more of processing circuitry 36, processor 38, node management unit 24, radio interface 30, etc.

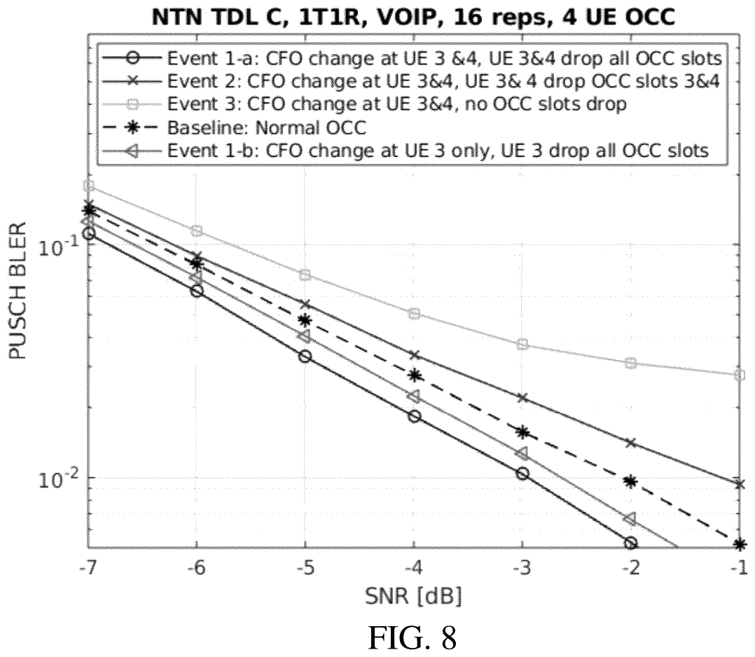

FIG. 8 shows OCC performance of OCC4 that is compared with and without the event of the CFO change. As illustrated in FIG. 6, the UE 22a (UE1) to UE 22d (UE4) are scheduled with OCC transmission within an OCC time window. The baseline illustrates the case where the CFO variance between UE 22a (UE1) and UE 22d (UE4) is within a certain limit (e.g., CFO spread less than 100 Hz), and the difference between the mean of CFO measured for UE 22a (UE1) to UE 22d (UE4) is below a certain limit (e.g., less than 0.01). The events in FIG. 6 may be defined as follows:
Event 1-a represents a case where UE 22c (UE3) and UE 22d (UE4) make a frequency adjustment at scheduled OCC time slot #3, and UE 22c (UE3) and UE 22d (UE4) drop all scheduled OCC slots;
Event 2 represents a case where UE 22c (UE3) and UE 22d (UE4) make a frequency adjustment at scheduled OCC time slot #3, and UE 22c (UE3) and UE 22d (UE4) drop only scheduled OCC slot #3 and #4;
Event 3 represents a case where UE 22c (UE3) and UE 22d (UE4) make a frequency adjustment at scheduled OCC time slot #3, and UE 22c (UE3) and UE 22d (UE4) do not drop scheduled OCC slot #3 and #4 but continue to transmit all scheduled time slots; and
Event 1-b represents a case where only UE 22c (UE3) make a frequency adjustment at scheduled OCC time slot #3 and UE 22c (UE3) drops all scheduled OCC slots.

From the simulated OCC performance, a degradation is observed if the UE 22 introduces a frequency adjustment during OCC transmission and does not drop any scheduled OCC transmission (i.e., scheduled OCC slots). OCC performance may be maintained if the UE 22 drops all the scheduled OCC transmission and/or if the UE would introduce the frequency jump during the OCC transmission. Below embodiments are designated to cope with OCC performance degradation caused by frequency jump initiated by UE 22.

### Embodiments Relating to the UE 22

Events that may cause the frequency error change and/or phase change between different time slot transmission may be defined as one or more of:
1. Frequency pre-compensation for the doppler frequency, e.g., according to clause 16.14.2.2 of 3GPP Technical Standard (TS) 38.300 v18.4.0;
2. Uplink timing adjustment in response to a timing advance command, e.g., according to clause 4.2 of 3GPP TS 38.213 v18.5.0; and/or
3. Autonomous uplink timing adjustment based on satellite ephemeris and UE 22 position, e.g., according to clause 4.2 of 3GPP TS 38.213 v.18.5.0.

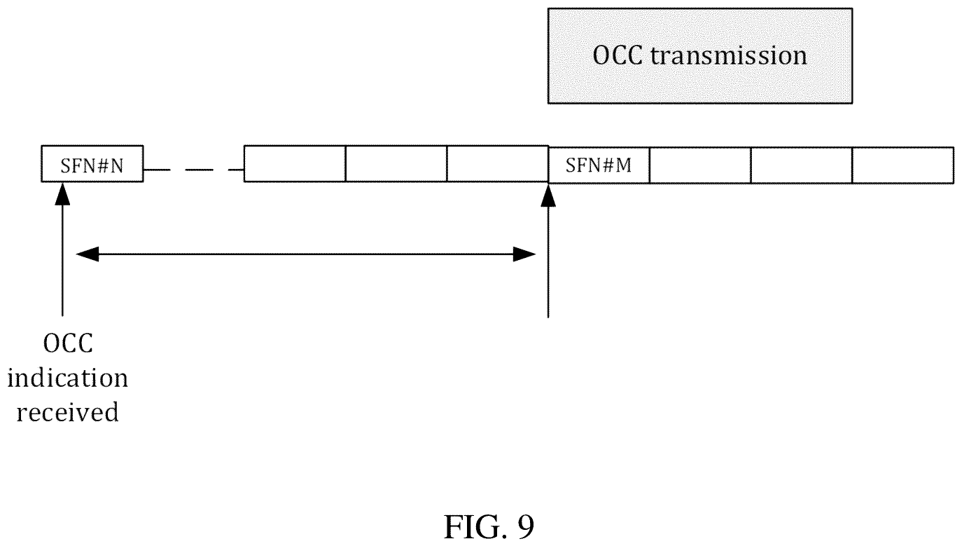

FIG. 9 shows an example of a single OCC occasion transmission. In some embodiments, as illustrated in FIG. 7, the UE 22 may be scheduled with a single OCC transmission occasion with (e.g., or via) a network indication. In some embodiments, one or more rules may be applied by the UE 22 when the received scheduling information indicates the usage of an OCC codeword larger than 2 (e.g., OCC length 4), if one of the events defined in the previous embodiment would cause a CFO change. One or more rules may be as follows:
1. One or more of the events listed above, e.g., frequency pre-compensation, uplink timing adjustment and autonomous uplink timing adjustment, may not be applied by the UE 22 during the OCC transmission duration;
2. One or more of the events listed above, e.g., frequency pre-compensation, uplink timing adjustment and autonomous uplink timing adjustment, may not be applied before the OCC transmission and after the OCC scheduling indication is received from the network node 16;
3. The OCC transmission may be dropped if one of the events listed in the previous embodiments is applied before the OCC transmission and after the OCC scheduling indication is received from network node 16; and/or
4. All the OCC transmission may be dropped if one of the events listed in the previous embodiments is applied during the time slots scheduled for OCC transmission.

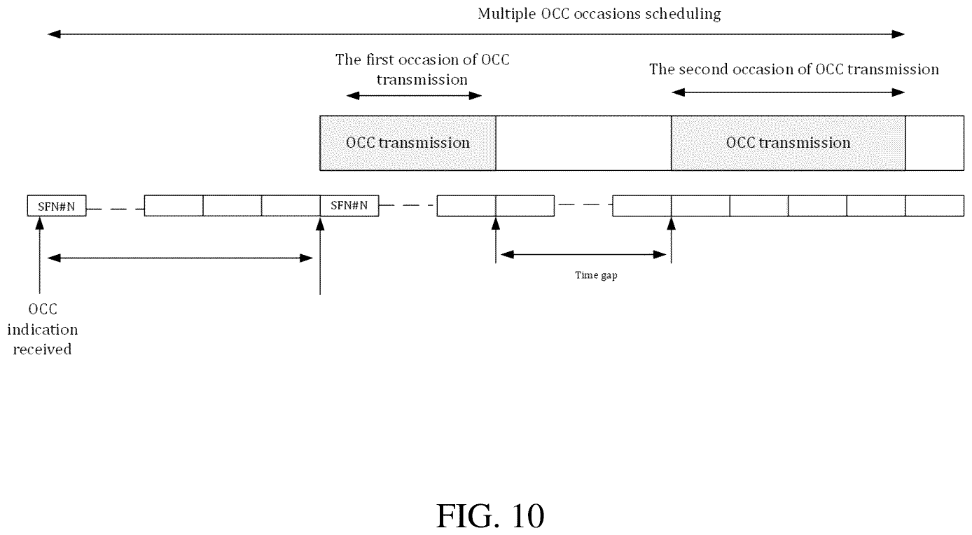

FIG. 10 shows an example of a multiple OCC occasion transmission. In some embodiments, as illustrated in FIG. 8, the UE 22 may be scheduled with multiple OCC transmission occasions with a network indication. One or more rules may be applied by the UE 22 for the scheduled OCC length 4 transmission for the first OCC transmission and if one of the events defined above would cause the CFO change. The rules may include one or more of:
1. One or more of the events above may not be applied to UE 22 during the OCC transmission duration;
2. One or more of the events above may not be applied before the OCC transmission and after the OCC scheduling indication is received from network node 16;
3 The OCC transmission may be dropped if one of the events above is applied before the OCC transmission and after the OCC scheduling indication is received from network node 16; and/or
4. All the OCC transmission may be dropped if one of the events above is applied during the time slots scheduled for OCC transmission.

One or more rules may be applied by the UE 22 for the scheduled OCC length 4 transmission for the second OCC transmission. These rules may be any of the following:
1. One or more of the events above may not be applied to UE 22 during the OCC transmission duration; and/or
2. All the OCC transmission may be dropped if one or more of the events above is applied during the time slots scheduled for OCC transmission

In some embodiments, a rule may be applied by the UE 22 in case the event below may occur after receiving the OCC scheduling indication and before OCC transmission. This may ensure that may all of the UEs 22 scheduled for OCC transmission compensate for the doppler frequency. That is, when the mean of the CFO is zero, and only the variance of the CFO should be measured. Frequency pre-compensation for the doppler frequency may be performed, e.g., according to clause 16.14.2.2 of 3GPP TS 38.300 v18.4.0.

### Embodiments Related to Network (e.g., Network Node 16) Behavior

In some embodiments, the network node 16 measures the frequency offsets of UE transmissions from a set of UEs 22. One or more of the following may be performed (e.g., by the network node 16):
1. Measuring the frequency error of the received signal transmitted from a number of UEs 22;
2. Grouping the UEs 22 for OCC scheduling with a condition listed below or at least satisfied a/b/c:
a. The variance of frequency error of each UE 22 is below a certain threshold; and/or
b. The difference of the mean frequency error of each UE 22 is below a certain threshold; and/or
3. Scheduling the UEs 22 qualified with condition in step 2 and the OCC scheme with one group.

In some embodiments, the network node 16 may schedule the OCC2 for any group of 2 of UEs 22 and then schedule OCC4 with CFO grouping criteria stated above.

In some embodiments, the network node 16 may indicate to the UE 22 to not adjust its CFO, transmission power, phase, or indicate to the UE 22 to drop the OCC transmission. The indication may be via downlink control information (DCI).

In some embodiments, the network node 16 may indicate that the event below may be applied at the UE 22 after receiving the OCC scheduling indication and before OCC transmission. Frequency pre-compensation for the doppler frequency may be according to clause 16.14.2.2 of 3GPP TS 38.300 v18.4.0.

### Additional Embodiments

One or more embodiments are applicable to an NTN deployment using “one beam per cell”.

One or more embodiments are applicable to an NTN deployment using “more than one beam per cell”.

In some embodiments, an NTN NR UE 22 may also encompass or include a reduced capability UE 22 also known as RedCap or eRedCap supporting non-terrestrial communications.

One or more embodiments are applicable to IoT-NTN, encompassing both LTE-MTC over NTN and NB-IoT over NTN.

One or more embodiments are applicable to a non-terrestrial network scenario based on transparent payload or regenerative payload.

One or more embodiments are applicable to different satellite orbits such as Low Earth Orbit (LEO), Medium Earth Orbit (MEO), and Geostationary Earth Orbit (GEO).

One or more embodiments are applicable to Frequency Division Duplex (FDD) and/or Time Division Duplex (TDD).

One or more embodiments are applicable to OCC length 2 instead of, or in addition to, OCC length 4.

Some embodiments may include one or more of the following:

Embodiment A1. A method in a network node configured to communicate with at least one user equipment (UE) of a plurality of UEs, the method comprising:
measuring a frequency error of a received signal transmitted from at least one UE of the plurality of UEs;
determining a group of UEs of the plurality of UEs based on the frequency error, the group of UEs being usable at least by the network node for Orthogonal Cover Code (OCC) scheduling based on one or more conditions; and
scheduling at least one UE of the group of UEs for OCC transmission based on the one or more conditions.

Embodiment A2. The method of Embodiment A1, wherein the one or more conditions include one or both of:
a variance of the frequency error associated with each UE is below a first predetermined threshold; and
a difference of a mean frequency error associated with each UE is below a second predetermined threshold.

Embodiment A3. The method of Embodiment A1 and A2, wherein the group is associated with an OCC scheme.

Embodiment A4. The method of Embodiment A1-A3, wherein the scheduling includes scheduling an OCC2 for any group of two of the UEs and scheduling OCC4 with a Carrier Frequency Offset (CFO) grouping criteria.

Embodiment A5. The method of Embodiment A1-A4, wherein the method further includes one or both of:
transmitting a first indication indicating the UE not to adjust one or more of CFO, transmission power, and phase; and
transmitting a second indication indicating the UE to drop an OCC transmission.

Embodiment B1. A network node configured to communicate with at least one user equipment (UE) of a plurality of UEs, the network node configured to, and/or comprising a radio interface and/or comprising processing circuitry configured to:
measure a frequency error of a received signal transmitted from at least one UE of the plurality of UEs;
determine a group of UEs of the plurality of UEs based on the frequency error, the group of UEs being usable at least by the network node for Orthogonal Cover Code (OCC) scheduling based on one or more conditions; and
schedule at least one UE of the group of UEs for OCC transmission based on the one or more conditions.

Embodiment B2. The network node of Embodiment B1, wherein the one or more conditions include one or both of:
a variance of the frequency error associated with each UE is below a first predetermined threshold; and
a difference of a mean frequency error associated with each UE is below a second predetermined threshold.

Embodiment B3. The network node of Embodiment B1 and B2, wherein the group is associated with an OCC scheme.

Embodiment B4. The network node of Embodiment B1-B3, wherein the scheduling includes scheduling an OCC2 for any group of two of the UEs and scheduling OCC4 with a Carrier Frequency Offset (CFO) grouping criteria.

Embodiment B5. The network node of Embodiment B1-B4, wherein the network node is further configured to one or both of:
transmit a first indication indicating the UE not to adjust one or more of CFO, transmission power, and phase; and
transmit a second indication indicating the UE to drop an OCC transmission.

Embodiment C1. A method in a user equipment (UE) of a plurality of UEs, the UE being configured to communicate with a network node and being scheduled for one or more Orthogonal Cover Code (OCC) transmissions based on the one or more conditions, the method comprising:
receiving one of a first indication and a second indication, the first indication indicating a first scheduling of the UE with a single OCC transmission occasion, the second indication indicating a second scheduling of the UE with multiple OCC transmission occasions;
determining, based on one or both of the first indication and the second indication, whether to apply one or more events associated with a frequency adjustment and dropping of one or more OCC resources; and
performing one or more actions based on the determination.

Embodiment C2. The method of Embodiment C1, wherein if one or both of the first indication and the second indication further indicates usage of an OCC codeword larger than 2 or usage of an OCC length 4 transmission for a first OCC transmission, and if one of one or more events cause a Carrier Frequency Offset (CFO) change, the one or more actions include one or more of:
determining not to apply the one or more events during OCC transmission duration;
determining not to apply the one or more events applied before the OCC transmission and after the corresponding OCC scheduling indication is received from the network node;
dropping an OCC transmission if the one or more events is applied before the OCC transmission and after the corresponding OCC scheduling indication is received from the network node; and
dropping all OCC transmissions if one of the events is applied during one or more time slots scheduled for the OCC transmission.

Embodiment D1. A user equipment (UE) of a plurality of UEs, the UE being configured to communicate with a network node and being scheduled for one or more Orthogonal Cover Code (OCC) transmissions based on the one or more conditions, the UE configured to, and/or comprising a radio interface and/or processing circuitry configured to:
receive one of a first indication and a second indication, the first indication indicating a first scheduling of the UE with a single OCC transmission occasion, the second indication indicating a second scheduling of the UE with multiple OCC transmission occasions;
determine, based on one or both of the first indication and the second indication, whether to apply one or more events associated with a frequency adjustment and dropping of one or more OCC resources; and
perform one or more actions based on the determination.

Embodiment D2. The UE of Embodiment C1, wherein if one or both of the first indication and the second indication further indicates usage of an OCC codeword larger than 2 or usage of an OCC length 4 transmission for a first OCC transmission, and if one of one or more events cause a Carrier Frequency Offset (CFO) change, the one or more actions include one or more of:
determining not to apply the one or more events during OCC transmission duration;
determining not to apply the one or more events applied before the OCC transmission and after the corresponding OCC scheduling indication is received from the network node;
dropping an OCC transmission if the one or more events is applied before the OCC transmission and after the corresponding OCC scheduling indication is received from the network node; and
dropping all OCC transmissions if one of the events is applied during one or more time slots scheduled for the OCC transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method in a network node configured to communicate with a plurality of UEs, the method comprising:
measuring a frequency error of received signals that are transmitted from the plurality of UEs;
grouping the UEs of the plurality of UEs for Orthogonal Cover Code (OCC) scheduling according to an OCC scheme, the grouping being based at least in part on a condition, the condition being based at least in part on a characteristic of the frequency error; and
scheduling at least one UE of the group of UEs for OCC transmission using the OCC scheme upon occurrence of the condition.

2. The method of claim 1, wherein a characteristic of the frequency error includes at least one of a variance of the frequency error and a difference of the mean frequency error.

3. The method of claim 2, wherein the condition includes at least one of:
the variance of the frequency error being below a first predetermined threshold; and
the difference of the mean frequency error being below a second predetermined threshold.

4. The method of claim 1, further comprising:
applying frequency pre-compensation; and
applying a rule for frequency pre-compensation, the rule including at least one of:
not applying frequency pre-compensation during an OCC transmission duration;
not applying frequency pre-compensation before the OCC transmission or after an OCC scheduling indication is received from the network node;
dropping an OCC transmission when the frequency pre-compensation is applied before the OCC transmission and after an OCC scheduling indication is received from the network node; and
dropping OCC transmissions when the frequency pre-compensation is applied during time slots scheduled for OCC transmission.

5. The method of claim 4, wherein the rule is applied in case of a single occasion of contiguous OCC transmission or for a scheduled OCC length 4 transmission when an event that causes a change in carrier frequency offset (CFO) occurs.

6. The method of claim 4, wherein the rule is applied when scheduling information indicates use of an OCC codeword longer than 2.

7. The method of claim 6, wherein the rule is applied in an event that causes a change in carrier frequency offset (CFO).

8. A network node configured to communicate with a plurality of UEs, the network node comprising processing circuitry configured to:
measure a frequency error of received signals that are transmitted from the plurality of UEs;
group the UEs of the plurality of UEs for Orthogonal Cover Code (OCC) scheduling according to an OCC scheme, the grouping being based at least in part on a condition, the condition being based at least in part on a characteristic of the frequency error; and
schedule at least one UE of the group of UEs for OCC transmission using the OCC scheme upon occurrence of the condition.

9. The network node of claim 8, wherein a characteristic of the frequency error includes at least one of a variance of the frequency error and a difference of the mean frequency error.

10. The network node of claim 9, wherein the condition includes at least one of:
the variance of the frequency error being below a first predetermined threshold; and
the difference of the mean frequency error being below a second predetermined threshold.

11. The network node of claim 8, wherein the processing circuitry is further configured to:
apply frequency pre-compensation; and
apply a rule for frequency pre-compensation, the rule including at least one of:
not applying frequency pre-compensation during an OCC transmission duration;
not applying frequency pre-compensation before the OCC transmission or after an OCC scheduling indication is received from the network node;
dropping an OCC transmission when the frequency pre-compensation is applied before the OCC transmission and after an OCC scheduling indication is received from the network node; and
dropping OCC transmissions when the frequency pre-compensation is applied during time slots scheduled for OCC transmission.

12. The network node of claim 11, wherein the rule is applied in case of a single occasion of contiguous OCC transmission or for a scheduled OCC length 4 transmission when an event that causes a change in carrier frequency offset (CFO) occurs.

13. The network node of claim 11, wherein the rule is applied when scheduling information indicates use of an OCC codeword longer than 2.

14. The network node of claim 13, wherein the rule is applied in an event that causes a change in carrier frequency offset (CFO).

15. A method in a user equipment (UE) configured to communicate with a network node, the method comprising:
for an occasion of contiguous orthogonal cover code (OCC) transmission, applying a rule for frequency pre-compensation, the rule including at least one of:
not applying frequency pre-compensation during an OCC transmission duration;
not applying frequency pre-compensation before the OCC transmission or after an OCC scheduling indication is received from the network node;
dropping an OCC transmission when the frequency pre-compensation is applied before the OCC transmission and after an OCC scheduling indication is received from the network node; and
dropping OCC transmissions when the frequency pre-compensation is applied during time slots scheduled for OCC transmission.

16. The method of claim 15, wherein the rule is applied in case of a single occasion of contiguous OCC transmission.

17. The method of claim 16, wherein the rule is applied when scheduling information indicates use of an OCC codeword longer than 2.

18. A user equipment (UE) configured to communicate with a network node, the UE including processing circuitry configured to:
for an occasion of contiguous orthogonal cover code (OCC) transmission, apply a rule for frequency pre-compensation, the rule including at least one of:
not applying frequency pre-compensation during an OCC transmission duration;
not applying frequency pre-compensation before the OCC transmission or after an OCC scheduling indication is received from the network node;
dropping an OCC transmission when the frequency pre-compensation is applied before the OCC transmission and after an OCC scheduling indication is received from the network node; and
dropping OCC transmissions when the frequency pre-compensation is applied during time slots scheduled for OCC transmission.

19. The UE of claim 18, wherein the rule is applied in case of a single occasion of contiguous OCC transmission.

20. The UE of claim 19, wherein the rule is applied when scheduling information indicates use of an OCC codeword longer than 2.
